(19) United States
(12) Patent Application Publication
(10) Pub. No.: US 2017/0120431 A1
(43) Pub. Date: May 4, 2017

(54) Illuminated Socket Wrench

(71) Applicant: Glenford Lawrence, FT. LAUDERDALE, FL (US)

(72) Inventor: Glenford Lawrence, FT. LAUDERDALE, FL (US)

(21) Appl. No.: 15/339,857

(22) Filed: Oct. 31, 2016

Related U.S. Application Data
(60) Provisional application No. 62/247,855, filed on Oct. 29, 2015.

(51) Int. Cl. B25B 23/18; B25B 23/00; F21V 23/04; F21V 33/00; F21L 4/00; B25B 13/06; B25B 13/46

(52) U.S. Cl. CPC B25B 23/18; B25B 13/06; B25B 23/0035; B25B 23/0021; B25B 13/462; F21V 33/0084; F21L 4/00; F21V 23/0421

(57) ABSTRACT

An illuminated socket wrench. The illuminated socket wrench is a socket wrench having a handle and working head with a light source placed at a working head. The handle forms an interior volume with an open end a removable cover that is made to seal the open end. A power source, such as removable batteries, is placed within the interior volume. A protrusion extends from the working head that is configured to attach to an interchangeable socket. Furthermore, an extendible arm may be attached to the protrusion, extending the reach of the wrench. Additionally, a light source is installed on the working head. A power switch is operably connected to the power source and placed at an accessible position on the handle.

### CROSS REFERENCE TO RELATED APPLICATIONS

This application claims the benefit of U.S. Provisional Application No. 62/247,855 filed on Oct. 29, 2015. The above identified patent application is herein incorporated by reference in its entirety to provide continuity of disclosure.

### BACKGROUND OF THE INVENTION

The present invention relates to socket wrenches. Spanners, or socket wrenches, are tools known in the prior art that are used to tighten various types of fasteners, such as bolts and nuts. Socket wrenches make use of the properties of torque, namely the physical relationship between the force applied to an object and the distance between the where the force is applied and the axis of rotation of the object. The effective torque increases in proportion to the distance perpendicular from that axis. As a result, a wrench produces more torque than a cylindrical tool with a smaller diameter turning along the same axis as the fastener being turned, such as a screwdriver.

Wrenches come in a multitude of shapes and sizes. The working ends of some wrenches are open ended while others form closed loops. A popular iteration of a wrench is a ratchet wrench, where a protrusion, such as a drive square, extends from a handle and is configured to attach to an interchangeable socket. The socket is placed on a fastener, for example the head of a bolt, and rotated. The ratcheting mechanism restricts the rotational motion of the socket to one direction, allowing a user to tighten a fastener in a situation offering limited mobility. However, many such situations are in hard to access areas, which often have limited lighting. Holding a flashlight to illuminate the work area can be cumbersome and unwieldy. Accordingly, a device offering a wrench with an integrated light source is desired.

### SUMMARY OF THE INVENTION

In view of the foregoing disadvantages inherent in the known types of socket wrenches now present in the prior art, the present invention provides a socket wrench wherein the same can be utilized for providing convenience for the user wishing to illuminate an area while utilizing a socket wrench. The present system comprises an elongated tool having a handle, a central shaft and a working head. The central shaft extends from the handle to the working head. The handle forms an interior volume with an open end a removable cover configured to seal the open end. A power source, such as removable batteries, is disposed within the interior volume. A drive square protrusion extends from the working head and a light source is disposed thereon. A power switch is operably connected to the power source and configured to control the light source.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of one embodiment of the illuminated socket wrench.

FIG. 2 shows a cut-away view of one embodiment of the illuminated socket wrench, showing the batteries stored within the handle.

FIG. 3 shows perspective view of a working end of the illuminated socket wrench.

FIG. 4 shows a perspective view of the removable and extendable arm of one embodiment of the illuminated socket wrench.

FIG. 5 shows a perspective view of the removable and extendable arm attached to the illuminated socket wrench.

### DETAILED DESCRIPTION OF THE INVENTION

Reference is made herein to the attached drawings. Like reference numerals are used throughout the drawings to depict like or similar elements of the illuminated socket wrench. The figures are intended for representative purposes only and should not be considered to be limiting in any respect.

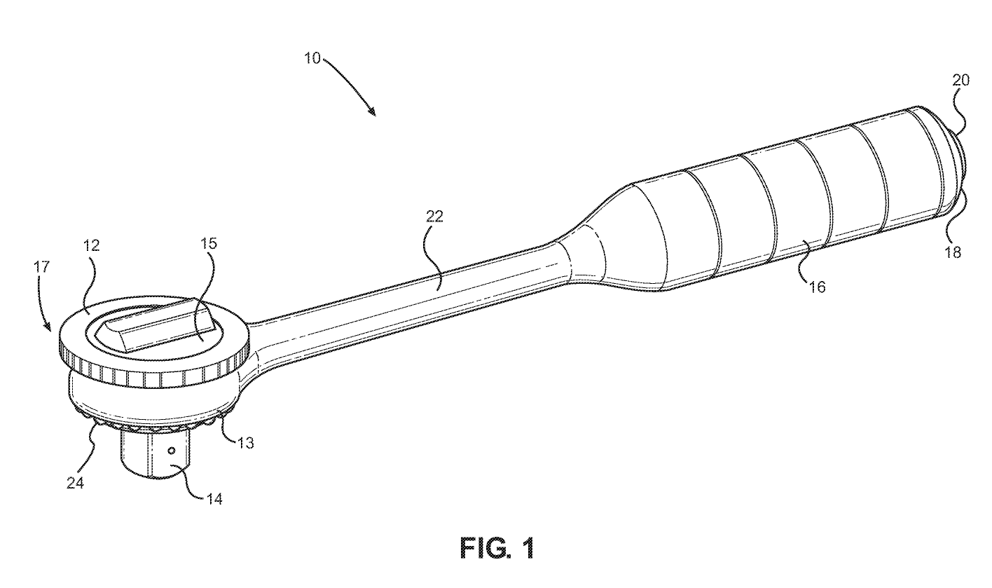

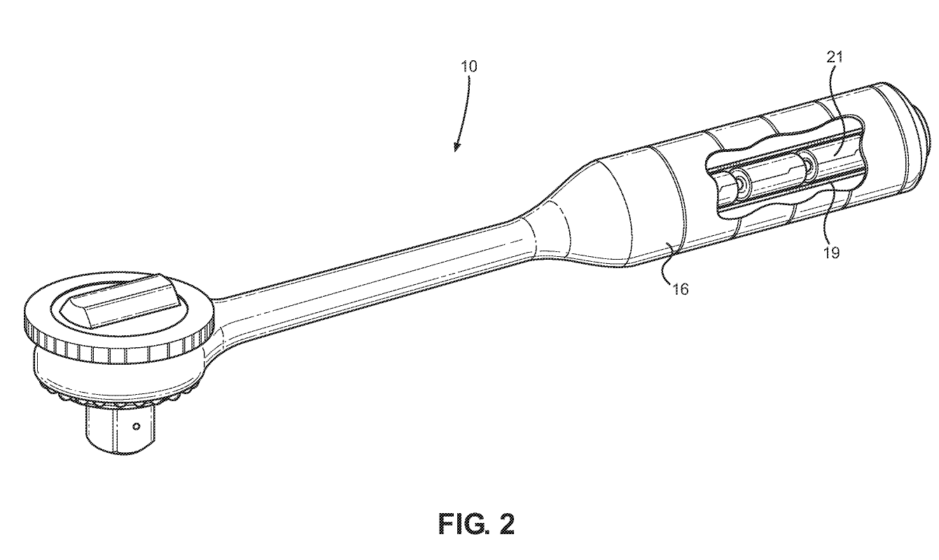

Referring now to FIGS. 1 and 2, there is shown a perspective view and a cutaway perspective view of one embodiment of the illuminated socket wrench, respectively. The illuminated socket wrench 10 comprises an elongated tool having a handle 16, a linearly aligned central shaft 22 and a working head 17. The working head 17 comprises a top end 12 and a bottom end 13, the bottom end 13 having a drive square 14 extending perpendicular therefrom. A light source 24 is disposed on the bottom end 13. A power source 21 is operably connected to the light source 24. In some embodiments of the illuminated socket wrench 10, the handle 16, central shaft 22 and working head 17 comprise a unitary piece of metal, eliminating any potential weaknesses introduced by joints and increasing structural rigidity.

The handle 16 of the illuminated socket wrench 10 further comprises a hollow interior volume 19 therein, the handle 16 having closed sidewalls and an open end sealed by a detachable cover 18. The power source 21 may include one or more removable batteries that are stored within the interior volume 19. A power switch 20 is positioned on the detachable cover 18 and configured to control the light source. In further embodiments, the power switch 20 is disposed on an exterior surface of the handle 16. The power switch 20 may be a click-style or toggle-style switch. The power switch 20 may further be configured to not only activate and deactivate the light, but control the brightness as well. For example, the switch may be rotated to control the brightness in proportion to the degree of rotation of the switch.

Some embodiments of the illuminated socket wrench 10 comprise a ratcheting mechanism well known the art. The ratcheting mechanism is positioned within the working head 17 and is operably connected to the drive square 14. The ratcheting mechanism is configured to restrain the rotation of the drive square 14 to a single direction. For example, the ratcheting mechanism may limit the motion of the drive square 14 to a clockwise direction relative to the working head 17, while preventing rotation in the counterclockwise direction. A directional lever 15 is disposed on the top end 12 of the working head 17 and is configured to shift the ratcheting mechanism between allowing the head 17 to rotate in a first direction while preventing the head 17 from rotating in an opposing second direction, and preventing the head 17 from rotating in the first direction while allowing the head 17 to rotate in the second direction.

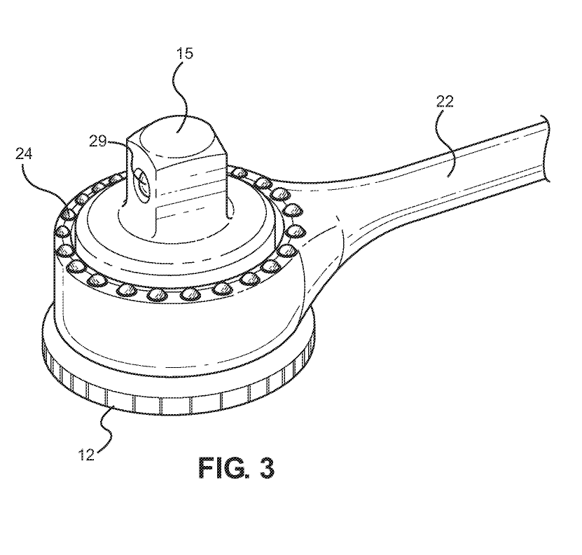

Referring now to FIG. 3, there is shown a perspective view of the working end of the illuminated socket wrench. In one embodiment of the illuminated socket wrench 10, the working head 17 comprises a disc shape disposed at one end of the central shaft 22. The drive square 14 extends from the working head 17 and is configured to be connected to a socket. In some embodiments of the illuminated socket wrench, the drive square 14 comprises a cuboid shape having a fastener adapted to easily secure a socket thereon. For example, the drive square 14 may contain a ball bearing 29 disposed one surface thereof, the ball bearing 29 configured to securely engage within a groove of a socket, holding the socket in place and preventing it from disengaging from the drive square 14 accidentally. In some embodiments, there is a release button configured to engage and disengage the ball bearing, allowing for easy mounting and dismounting of the socket. The socket is configured to receive a fastener, such as the head of a bolt, to a tight tolerance, such that when the socket turns, torque is applied to the fastener.

In some embodiments of the illuminated socket wrench 10, the light source 24 comprises a singular bulb, while in further embodiments the light source 24 comprises a plurality of bulbs disposed along the circumference of the working head 17 on the bottom end. Embodiments featuring one or more light sources positioned around the drive head 14 provide a user with even lighting illuminated a work are, reducing the shadows produced when compared to a single point light source. Some embodiments comprise a power switch 20 that is further configured to adjust the brightness of the light source, offering various levels of lighting for different scenarios.

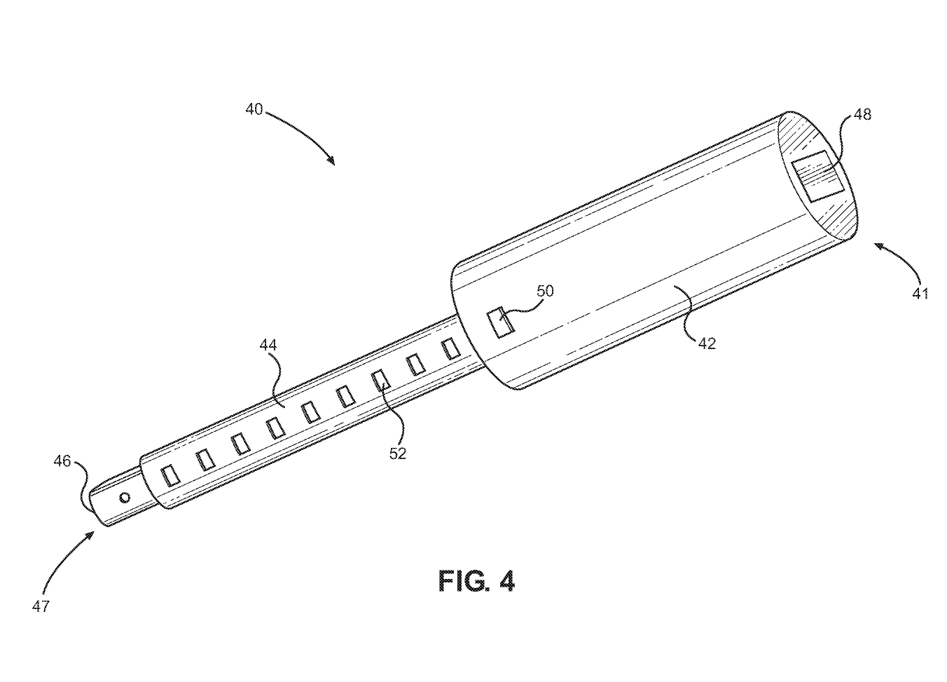

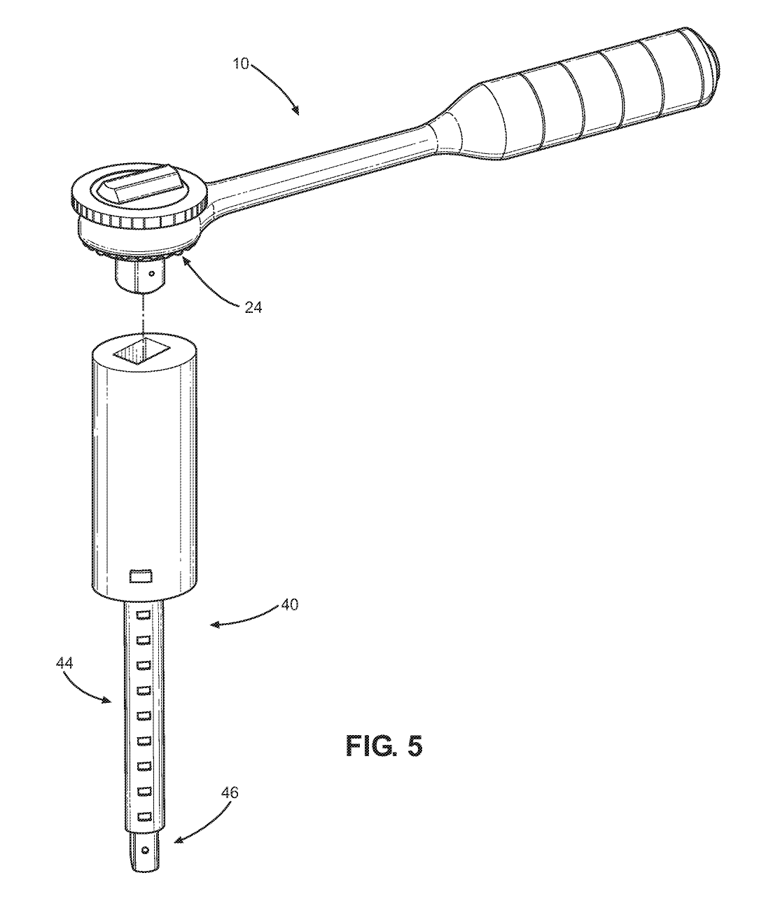

Referring now to FIGS. 4 and 5, there are shown perspective views of the removable and extendable arm of one embodiment of the illuminated socket wrench, and the removable and extendable arm attached to the illuminated socket wrench, respectively. The device further comprises a removable and extendable arm 40 adapted to removably engage with the socket wrench. The removable and extendable arm 40 comprises an elongated member having a cylindrical rod 42 and an extendible arm 44. The cylindrical rod 42 forms a tube having a proximal end 41 and a distal end 43. An aperture 48 is disposed on the proximal end 41, the aperture 48 configured to securely attached to the drive square 14 of the illuminated socket wrench 10. An interior channel extends through the cylindrical rod 42 and is adapted to receive the extendible arm 44 therein. The extendible arm 44 is configured to slide between a fully retracted position within the cylindrical rod 42 to a fully extended position, and can be locked in place at various intermediate positions via a locking mechanism 50. This retraction and extension allows a user to customize the length of the extendable arm to fit a desired situation.

In some embodiments of the illuminated socket wrench 10, the locking mechanism 50 comprises a locking pin disposed on the cylindrical rod 42 and a series of slots 52 positioned along a longitudinal length of the extendible arm 44. The extendible arm 44 is placed in the desired position, and the locking pin interlocks with a corresponding slot, locking the extendible arm 42 in place. The extendible arm 42 comprises a secondary drive square 46 at a distal end 47 additionally configured securely attach to a socket.

In use, the removable and extendable arm 40 may be attached to the illuminated socket wrench 10, offering a user an adjustable extension configured to increase the reach of the tool. The light source 24 is configured to illuminate an area around the secondary drive square 46, such that the work area is sufficiently lit up even if the extendible arm 44 is in a fully extended position.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An illuminated socket wrench, comprising:
an elongated tool having a handle, a central shaft and a working head, wherein the central shaft extends from the handle to the working head;
wherein the handle forms an interior volume having an open end;
a removable cover configured to seal the open end of the handle;
a power source disposed within the interior volume;
wherein the working head comprises a top end and bottom end, the bottom end having a drive square extending therefrom;
a light source disposed on the bottom end of the working head;
a power switch operably connected to the power source and the light source and configured to control the light source.

2) The illuminated socket wrench of claim 1, wherein the power switch is disposed on the cover.

3) The illuminated socket wrench of claim 1, wherein the light source comprises a series of light bulbs disposed along the perimeter of the bottom end of the working head.

4) The illuminated socket wrench of claim 1, wherein the handle, central shaft and working head comprise a unitary piece.

5) The illuminated socket wrench of claim 1, wherein the drive square comprises a cuboid shape.

6) The illuminated socket wrench of claim 5, wherein the drive square further comprises a ball bearing fastener configured to secure a socket thereto.

7) The illuminated socket wrench of claim 1, further comprising a ratcheting mechanism, the ratcheting mechanism configured to restrain the rotational motion of the drive square to a single direction.

8) The illuminated socket wrench of claim 7, further comprising a directional lever disposed on the top end of the working head, wherein the direction level is configured to control the direction of rotation of the ratcheting mechanism.

9) The illuminated socket wrench of claim 1, further comprising a removable and extendable arm, the removable and extendable arm comprising:
a cylindrical rod having a proximal end and a distal end and having an interior channel running therethrough;
an aperture disposed on the proximal end, the aperture configured to fit the drive square of the illuminate socket wrench therein;
an extendible arm disposed within the interior channel, the extendible arm further comprising a secondary drive square at one end thereof;
a fastening mechanism configured to secure the extendible arm in a desired position.

10) The illuminated socket wrench of claim 9, herein the fastening mechanism comprises a series of slots disposed along the extendible arm and a locking pin disposed on the cylindrical rod, wherein the locking pin is configured to interlock within a slot on the extendible arm, locking the extendible arm in place.
